(19) United States
(12) Patent Application Publication
(10) Pub. No.: US 2011/0004697 A1
(43) Pub. Date: Jan. 6, 2011

(54) ELECTRONIC APPARATUS AND COMMUNICATION CONTROL METHOD

(75) Inventor: Fumiyoshi TEZUKA, Ome-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/823,554

(22) Filed: Jun. 25, 2010

(30) Foreign Application Priority Data
Jul. 6, 2009 (JP) 2009-159977

(51) Int. Cl. G06F 15/16

(52) U.S. Cl. 709/232

(57) ABSTRACT

According to one embodiment, a electronic apparatus includes a coupler, a communication module configured to execute, with use of the coupler, wireless communication with an external device, and a file transmission module configured to execute file transmission with the external device by controlling the communication module. The file transmission module includes a module configured to receive from the external device a path designation command, which includes a header designating a folder name, in a push protocol, a module configured to receive from the external device a file by a push command for pushing data in the push protocol, and a module configured to use the folder name designated by the path designation command, thereby grouping the file that is received by the push command after the path designation command.

### CROSS-REFERENCE TO RELATED APPLICATIONS

This application is based upon and claims the benefit of priority from Japanese Patent Application No. 2009-159977, filed Jul. 6, 2009, the entire contents of which are incorporated herein by reference.

### FIELD

Embodiments described herein relate generally to an electronic apparatus which executes close proximity wireless transfer, and a communication control method which is applied to the electronic apparatus.

### BACKGROUND

In recent years, transmission/reception of a file is executed between electronic apparatuses by making use of close proximity wireless transfer. In a communication system disclosed in Jpn. Pat. Appln. KOKAI Publication No. 2009-027669, content data is transferred from a server apparatus (e.g. a DVD recorder or a hard disk recorder) to a mobile terminal by close proximity wireless transfer. In the communication system, communication is enabled if the distance between the server apparatus and the mobile terminal is within a predetermined range. If the distance between the server apparatus and the mobile terminal becomes greater than the communication range, the communication is disabled. Thus, for example, in the case where the position of the server apparatus is fixed, close proximity wireless transfer is enabled if the user holds the mobile terminal by the hand and approaches the mobile terminal to the server apparatus within a predetermined range, close proximity wireless transfer is enabled. If the mobile terminal is moved away from the server apparatus, the close proximity wireless transfer is disabled.

In this communication system, if the user keeps the mobile terminal within the communication range of the server apparatus, a plurality of files can continuously be received by the mobile terminal. If the user moves the mobile terminal out of the communication range of the server apparatus, the reception of files can be stopped. Thereby, without a time-consuming operation, only a necessary number of files (e.g. content data) can be taken in the mobile terminal from the server apparatus.

According to this communication system, the reception of files and the stop of the reception of files are controlled by the user's operation of varying the distance between the server apparatus and the mobile terminal. Thereby, only a necessary number of files can be transmitted from the server apparatus to the mobile terminal.

However, in the prior art, in the case of transmitting a plurality of files from the server apparatus to the mobile terminal, the files are simply transmitted in succession and stored in the mobile terminal.

Under the circumstance, for example, in the case where data, which has a single meaning by a plurality of files, such as a moving picture content composed of a plurality of files, is to be transmitted, if the plural files are simply transmitted, the association between the plural files would become unclear in the reception-side terminal, and the files would become meaningless.

In the meantime, before the plural files are transmitted, it is possible for the user to perform an operation for mutually associating the plural files, but in this case the advantageous of the high speed and easy transmission by the use of close proximity wireless transfer would be lost.

### BRIEF DESCRIPTION OF THE DRAWINGS

FIG. 1A and FIG. 1B is an exemplary external appearances of electronic apparatuses according to an embodiment of the present invention;

FIG. 2 is an exemplary block diagram showing the functional structure of the electronic apparatus according to the embodiment;

FIG. 3 is an exemplary diagram showing software architecture for controlling close proximity wireless transfer in the present embodiment;

FIG. 4 is an exemplary diagram showing “Field” and “Header” which are used in “CONNECT Request” of “CONNECT Operation” in the embodiment;

FIG. 5 is an exemplary diagram showing “Field” and “Header” which are used in “CONNECT Response” of “CONNECT Operation” in the embodiment;

FIG. 6 is an exemplary diagram showing “Field” and “Header” which are used in “DISCONNECT Request” of “DISCONNECT Operation” in the embodiment;

FIG. 7 is an exemplary diagram showing “Field” and “Header” which are used in “DISCONNECT Response” of “DISCONNECT Operation” in the embodiment;

FIG. 8 is an exemplary diagram showing “Field” and “Header” which are used in “PUT Request” of “PUT Operation” in the embodiment;

FIG. 9 is an exemplary diagram showing “Field” and “Header” which are used in “PUT Response” of “PUT Operation” in the embodiment;

FIG. 10 is an exemplary diagram showing “Field” and “Header” which are used in “GET Request” of “GET Operation” in the embodiment;

FIG. 11 is an exemplary diagram showing “Field” and “Header” which are used in “GET Response” of “GET Operation” in the embodiment;

FIG. 12 is an exemplary diagram showing “Field” and “Header” which are used in “ABORT Request” of “ABORT Operation” in the embodiment;

FIG. 13 is an exemplary diagram showing “Field” and “Header” which are used in “ABORT Response” of “ABORT Operation” in the embodiment;

FIG. 14 is an exemplary diagram showing “Field” and “Header” which are used in “SETPATH Request” of “SETPATH Operation” in the embodiment;

FIG. 15 is an exemplary diagram showing “Field” and “Header” which are used in “SETPATH Response” of “SETPATH Operation” in the embodiment;

FIG. 16 is an exemplary diagram showing an operation which is used in a push protocol class in each of a client and a server, which execute data communication by close proximity wireless transfer in the present embodiment;

FIG. 17 is an exemplary diagram showing “Header ID” which is used in the push protocol class in the embodiment;

FIG. 18 is an exemplary diagram showing procedures for providing services by the push protocol class in the embodiment;

FIG. 19 is an exemplary diagram showing a “Connect” procedure of the push protocol class in the embodiment;

FIG. 20 is an exemplary diagram showing a “Get Capabilities” procedure of the push protocol class in the embodiment;

FIG. 21 is an exemplary diagram showing a “Set Path” procedure of the push protocol class in the embodiment;

FIG. 22 is an exemplary diagram showing a “Push Object” procedure of the push protocol class in the embodiment;

FIG. 23 is an exemplary diagram showing a “Get Default Object” procedure of the push protocol class in the embodiment;

FIG. 24 is an exemplary diagram showing a “Disconnect” procedure of the push protocol class in the embodiment;

FIG. 25 is an exemplary diagram showing an operation which is used in a file transfer protocol class in each of a client and a server, which execute data communication by close proximity wireless transfer in the present embodiment;

FIG. 26 is an exemplary diagram showing “Header ID” which is used in the file transfer protocol class in the embodiment;

FIG. 27 is an exemplary diagram showing a procedure for providing a service by the file transfer protocol class in the embodiment;

FIG. 28 is an exemplary diagram showing a “Connect” procedure of the file transfer protocol class in the embodiment;

FIG. 29 is an exemplary diagram showing a “Get Folder Listing” procedure of the file transfer protocol class in the embodiment;

FIG. 30 is an exemplary diagram showing a “Set Path” procedure of the file transfer protocol class in the embodiment;

FIG. 31 is an exemplary diagram showing a “Put Object” procedure of the file transfer protocol class in the embodiment;

FIG. 32 is an exemplary diagram showing a “Get Object” procedure of the file transfer protocol class in the embodiment;

FIG. 33 is an exemplary diagram showing a “Disconnect” procedure of the file transfer protocol class in the embodiment;

FIG. 34 is an exemplary diagram showing a sequence which is executed between the client and server which execute file transmission/reception in the embodiment;

FIG. 35 is an exemplary flow chart showing the operation of an application/OBEX server in the embodiment; and

FIG. 36 is an exemplary diagram showing grouping of files in the case where a plurality of files are transmitted from a digital camera to a personal computer in the embodiment.

### DETAILED DESCRIPTION

In general, according to one embodiment, there is provided an electronic apparatus includes a coupler, a communication module configured to execute, with use of the coupler, wireless communication with an external device, and a file transmission module configured to execute file transmission with the external device by controlling the communication module. The file transmission module includes a module configured to receive from the external device a first path designation command, which includes a header designating a first folder name, in a push protocol, a module configured to receive from the external device a first file by a push command for pushing data in the push protocol, and a module configured to store the first folder name designated by the first path designation command and the first file that is received by the push command after the first path designation command.

An embodiment of the present invention will now be described with reference to the accompanying drawings.

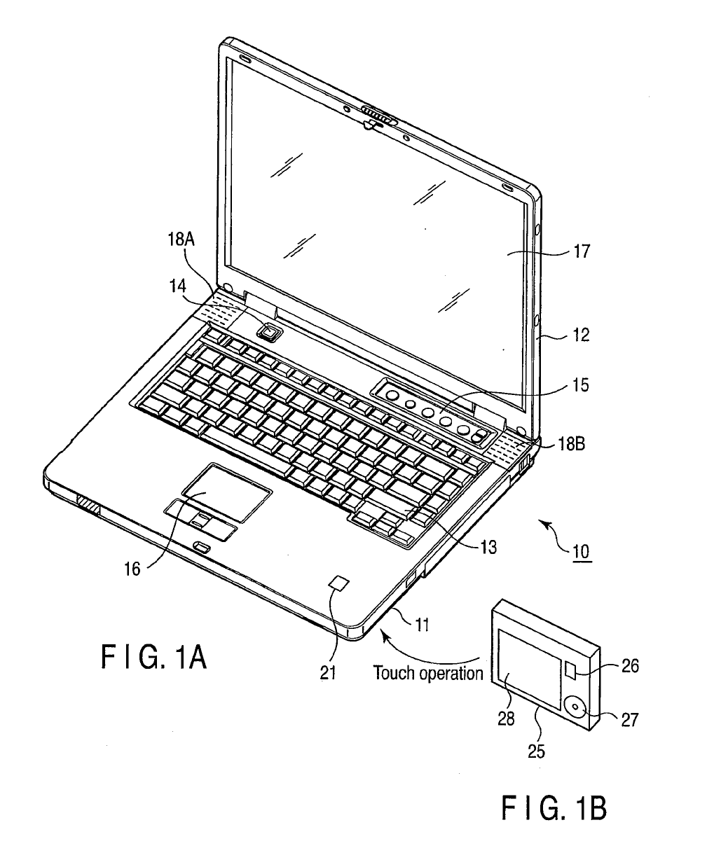

FIG. 1A and FIG. 1B show the external appearances of electronic apparatuses according to the embodiment of the invention. The electronic apparatus shown in FIG. 1A is realized, for example, as a notebook personal computer 10. The electronic apparatus shown in FIG. 1B is realized, for example, as a digital camera 25. The electronic apparatus in the embodiment is realized, for instance, as a digital video camera, a mobile phone, a PDA (personal digital assistant), an audio/video player, a car navigation apparatus, a TV, or a video recorder. In short, the electronic apparatus in the embodiment may be any kind of apparatus in which a processor for executing a program is mounted.

The electronic apparatus (personal computer 10, digital camera 25) in the present embodiment is equipped with a close proximity wireless transfer function. When the electronic apparatus is positioned in close proximity to some other electronic apparatus, data transfer can be executed. In the present embodiment, in the file transfer by close proximity wireless transfer, if a communication command on the transmission side is a specific folder designation command, the reception side generates specific attribute information for identification of a file which is attached to a transmission command that is sent thereafter. When a file transmission command is received from the transmission side, the file is stored together with the generated attribute information.

FIG. 1A shows the state in which a display unit of the personal computer 10 is opened. The personal computer 10 comprises a computer main body 11 and a display unit 12. A display device, which is composed of an LCD (Liquid Crystal Display) 17, is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for power-on/power-off, an input operation panel 15, a touch pad 16, and speakers 18A and 18B are disposed on the top surface of the housing of the computer main body 11.

The input operation panel 15 is an input device for inputting an event corresponding to a pressed button. The input operation panel 15 includes a plurality of buttons for activating a plurality of functions.

Further, an antenna 21 for close proximity wireless transfer is provided on an upper surface portion of the computer main body 11. The personal computer 10 is provided with a close proximity wireless transfer function for executing wireless communication with some other electric apparatus in the state in which the personal computer 10 is positioned close to the other electronic apparatus. The personal computer 10 executes data communication with some other electronic apparatus via the antenna 21 for close proximity wireless transfer.

On the other hand, the digital camera 25 shown in FIG. 1B is provided with a close proximity wireless transfer function for executing wireless communication with the personal computer 10 in the state in which the digital camera 25 is positioned close to the personal computer 10. The digital camera 25 is provided with, as well as an operation button 27 and a display 28, an antenna 26 for close proximity wireless transfer, which is disposed, for example, on a back side of the housing thereof.

When the user performs an operation (also referred to as “touch operation”) of bringing the antenna 26 for close proximity wireless transfer of the digital camera 25 close to the antenna 21 for close proximity wireless transfer of the personal computer 10, the digital camera 25 is able to start data communication by the close proximity wireless transfer function.

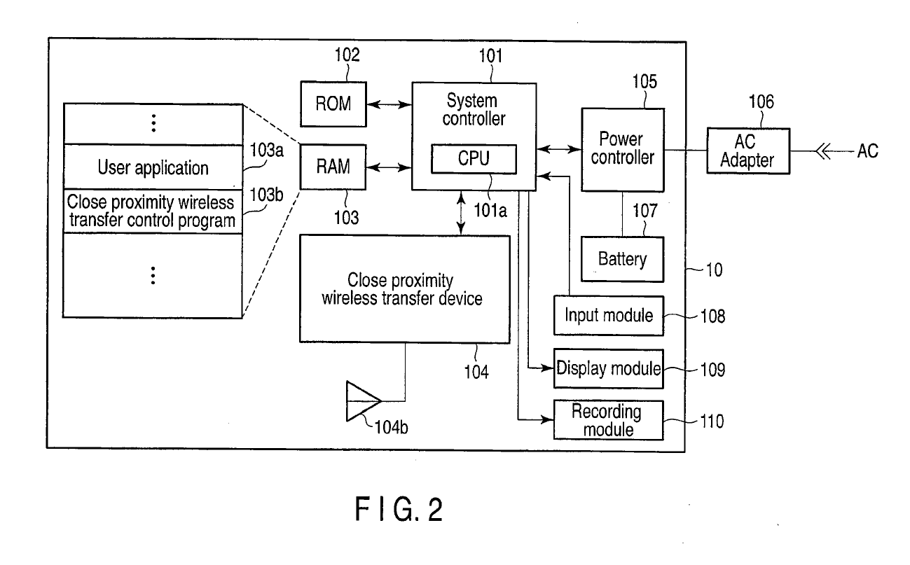

FIG. 2 is a block diagram showing the functional structure of the electronic apparatus according to the embodiment. The electronic apparatus shown in FIG. 2 is, for example, the personal computer 10. The personal computer 10 comprises a system controller 101, a ROM 102, a RAM 103, a close proximity wireless transfer device 104, a power controller 105, an AC adapter 106, a battery 107, an input module 108, a display module 109 and a recording module 110.

The system controller 101 controls the operations of the respective components in the electronic apparatus 10. The system controller 101 includes a CPU 101a, and is connected to the ROM 102, RAM 103, close proximity wireless transfer device 104, power controller 105, input module 108, display module 109 and recording module 110.

The CPU 101a is a processor which loads instructions and data, which are stored in the ROM 102, into the RAM 103, and executes necessary processes. A user application program 103a of any kind and a close proximity wireless transfer control program 103b for controlling close proximity wireless transfer are loaded in the RAM 103. The CPU 101a executes the close proximity wireless transfer control program 103b that is loaded in the RAM 103, thereby functioning as a file transfer module for executing file transmission with an external device, and controlling the close proximity wireless transfer device 104.

The close proximity wireless transfer device 104 is a communication module which executes close proximity wireless transfer. The close proximity wireless transfer device 104 establishes wireless connection to some other device (external device) having a close proximity wireless transfer function, which is present within a predetermined distance from the close proximity wireless transfer device 104, and starts transmission of data such as files. The close proximity wireless transfer between the close proximity wireless transfer device 104 and the external device is executed in a peer-to-peer mode. The communication distance is, e.g. 3 cm. The wireless connection between the close proximity wireless transfer device 104 and the external device is enabled only in the case where the close proximity wireless transfer device 104 and the external device are in a close proximity state, that is, only in the case where the close proximity wireless transfer device 104 and the external device are close to each other within the communication distance (e.g. 3 cm). When the close proximity wireless transfer device 104 and the external device are brought close to each other within the communication distance, the wireless connection between the close proximity wireless transfer device 104 and the external device is established. Then, transmission of data, such as a data file which is explicitly designated by the user, or a predetermined data file which is to be synchronized, is executed between the close proximity wireless transfer device 104 and the external device.

In the close proximity wireless transfer, an induction electric field is used. As a close proximity wireless transfer method, TransferJet™, for instance, can be used. TransferJet™ is a close proximity wireless transfer method which uses an ultra-wideband (UWB), and high-speed data transfer can be realized.

The close proximity wireless transfer device 104 is connected to an antenna 104b (antenna 21 for close proximity wireless transfer). The antenna 104b is an electrode called “coupler”, and executes data transmission/reception to/from the external device by a radio signal using an induction electric field. In the case where the external device comes near within the communication distance (e.g. 3 cm) from the antenna 104b, the antennas (couplers) of the close proximity wireless transfer device 104 and the external device are coupled by the induction electric field, and thereby wireless communication between the close proximity wireless transfer device 104 and the external device is enabled. In the meantime, the close proximity wireless transfer device 104 and the antenna 104b can be realized as a single module.

The power controller 105 supplies power to the respective components within the electronic apparatus 10 by using power which is supplied from the outside via the AC adapter 106 or power which is supplied from the battery 107. In other words, the electronic apparatus 10 is driven by an external power supply such as an AC commercial power supply, or by the battery 107. The AC adapter 106 may be provided within the electronic apparatus 10.

The input module 108 controls an input from an input device, such as the keyboard 13, touch pad 16 or other buttons.

The display module 109 controls display on the LCD 17.

The recording module 110 records data by means of recording media such as a hard disk or a flash memory. Various kinds of files are recorded in the recording module 110 by the execution of the application program. A file, which is recorded in the recording module 110, is an object of transmission/reception by close proximity wireless transfer with some other electronic apparatus. In the recording module 110, files are recorded in such a manner that the files are classified, for example, into logically structured folders.

The other electronic apparatus, such as the digital camera 25, includes the same module as shown in the block diagram of FIG. 2, and close proximity wireless communication is realized by executing the close proximity wireless transfer control program 103b by the CPU 101a (the module functioning as a file transmission module which executes file transmission with the external device).

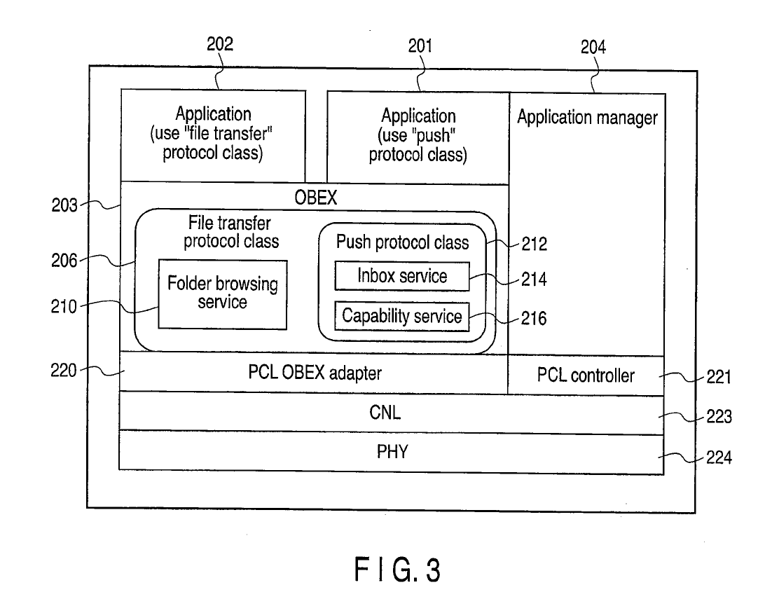

Next, referring to FIG. 3, a description is given of the software architecture (file transmission module) for controlling the close proximity wireless transfer in the present embodiment.

The software architecture shown in FIG. 3 shows a hierarchical structure of a protocol stack for controlling close proximity wireless transfer. The protocol stack comprises a physical layer (PHY 224), a connection layer (CNL 223), a protocol conversion layer (PCL OBEX (object exchange) adapter 220, PCL controller 221), and an application layer (applications 201 and 202, OBEX protocol 203, application manager 204). For example, the connection layer (CNL), protocol conversion layer (PCL) and application layer are realized by the close proximity wireless transfer control program 103b.

The physical layer (PHY 224) is a layer which controls physical data transfer, and corresponds to a physical layer in an OSI reference model. A part or all of the functions of the physical layer (PHY 224) can be realized by using hardware within the close proximity wireless transfer module 104.

The physical layer (PHY 224) converts data from the connection layer (CNL 223) to a radio signal. The connection layer (CNL 223) corresponds to a data link layer and a transport layer within the OSI reference model, and executes data communication by controlling the physical layer (PHY 224). Responding to a connection request from the protocol conversion layer (PCL OBEX adapter 220) or a connection request from the external device, the connection layer (CNL 223) executes a process of establishing connection (CNL connection) between the close proximity wireless transfer module 104 and the external device which are set in the close proximity state. The protocol conversion layer (PCL OBEX adapter 220) corresponds to a session layer and a presentation layer in the OSI reference model, and is positioned between the application layer and the connection layer (CNL 223) for controlling the establishment/release of connection between electronic apparatuses. The protocol conversion layer (PCL OBEX adapter 220) executes control of each application (communication program) within the application layer and control of the connection layer (CNL 223).

To be more specific, the protocol conversion layer (PCL OBEX adapter 220) executes a conversion process for converting the data (user data) corresponding to the application protocol (e.g. OBEX protocol 203, SCSI, or other general-use protocol), which is handled by each communication program of the application layer, to a specific transmission data format. By this conversion process, whichever communication program is used when data is transmitted/received, the data can be converted to a packet (data of a specific transmission data format) which can be handled by the connection layer (CNL 223). This protocol conversion layer (PCL OBEX adapter 220) makes it possible to use various application protocols in the close proximity wireless transfer.

In addition, the protocol conversion layer (PCL) executes a process of exchanging service information (information indicative of services which can be provided by each device) and session information (information relating to a session that is the object of connection establishment/release) with the communication counterpart device, and also executes activation of the application, management of connection, and management of sessions.

The user application layer includes a plurality of communication programs corresponding to some application protocols, such as the OBEX protocol 203, SCSI, and other general-use protocols. In the present embodiment, a description is given of the case of transmitting/receiving data by the OBEX protocol 203 shown in FIG. 3.

The OBEX protocol 203 establishes CNL connection by the PCL controller 221 which is controlled by the application manager 204, and executes communication via The PCL OBEX adapter 220. In the OBEX protocol 203, application stipulations (hereinafter referred to as “protocol class”) for enabling mutual data transmission/reception between OBEX applications are defined. Each of the applications 201 and 202 can execute transmission/reception of objects, such as files, by making use of an OBEX protocol procedure according to the protocol class. In the OBEX protocol 203 in the embodiment, a file transfer protocol class 206 and a push protocol class 212 are defined as basic protocol classes.

The push protocol class 212 is used in order to transmit one or plural files from a client to a server. In the push protocol class 212, a procedure (function) for the client (e.g. digital camera 25) to put (“PUT”) and deliver an arbitrary file to the server (e.g. personal computer 10) is defined. In the push protocol class 212, the procedure, which is necessary before transmitting files by close proximity wireless transfer (TransferJet™), is simplified, and thereby the operational load on the user is decreased and high-speed data communication is realized. It is assumed that an INBOX service 214 in the push protocol class 212 executes a procedure based on an INBOX service that is described in the specification of already known “IrDA Object Exchange Protocol Version 1.4”, and a detailed description of the INBOX service 214 is omitted here. A capability service 216 is used in order to acquire data which is indicative of the capability of the server side.

The file transfer protocol class 206 is used in order to execute transmission/reception of one or plural files between the client and the server. In the file transfer protocol class 206, a procedure for supporting file transfer, which corresponds to FTP (File Transfer Protocol), and a file/folder operation, is defined.

In the file transfer protocol 206, unlike the file transfer using the push protocol class 212, data (folder information), which is indicative of the folder and file at the transmission destination (server) of the file, is acquired from the server by a folder browsing service 210 before the file is transmitted. On the basis of the folder information, the movement (creation) of a folder is executed to the transmission destination of the file, and the file can be transmitted. The file transfer protocol class 206 is a procedure based on a folder browsing service that is described in the already known “IrDA Object Exchange Protocol Version 1.4”, and a to-be-operated folder is designated to the server by a SETPATH operation. In addition, file information of a file included in a to-be-operated folder and folder information is acquired from the server in a “Folder Listing Object” format, and the to-be-operated file or folder can be designated. The folder browsing service 210 is an operation according to already known materials, and so a detailed description thereof is omitted.

As shown in FIG. 3, the file transfer protocol class 206 has such a relationship as to include the push protocol class 212. Even at the time of file transmission using the file transfer protocol class 206, it is possible to use the INBOX service 214 and capability service 216.

In FIG. 3, the applications 201 and 202 correspond to the OBEX protocol 203. Each application 201, 202 executes a process of issuing a request for the start/end of a session to the protocol conversion layer (PCL), and a process of transmitting/receiving data via the protocol conversion layer (PCL).

The application 201 transfers one or plural files to the server by making use of the push protocol 212 of the OBEX protocol 203. The application 202 transmits/receives one or plural files to/from the server by making use of the OBEX protocol 203.

Next, the OBEX protocol 203 is described in detail. In particular, a description is given of the OBEX object and protocol in the communication via the PCL OBEX adapter 220.

(1) OBEX Object

It is assumed that the object (data), which is handled in the OBEX protocol 203, conforms to “OBEX Object Model” which is defined in the specification of “IrDA Object Exchange Protocol Version 1.4”. In this case, it is assumed that the following three objects (a), (b) and (c) in the object format, which is defined in “IrDA Object Exchange Protocol Version 1.4”, are handled.

(a) “Folder Listing Object”

The “Folder Listing Object” is used in order to acquire the details of a server-side folder and file when the folder browsing service 210 is executed. The basic format conforms to the “IrDA Object Exchange Protocol Version 1.4”.

(b) “Generic File Object”

The “Generic File Object” is used in order to perform general-use file object exchange. The basic format conforms to the “IrDA Object Exchange Protocol Version 1.4”. A value, which conforms to the “IrDA Object Exchange Protocol Version 1.4” according to the kind of media, is designated in the TYPE header which is attached to the object.

(c) “Capability Object”

The “Capability Object” is used in order to acquire a server-side capability. The basic format conforms to the “IrDA Object Exchange Protocol Version 1.4”.

(2) Protocol

The OBEX protocol 203 establishes a PCL session by using “Control primitive” which is defined in “PCL OBEX Adapter Specification”, and executes an OBEX operation, which is defined by the “IrDA Object Exchange Protocol Version 1.4”, by using “PCL OBEX Service Primitive” on the session.

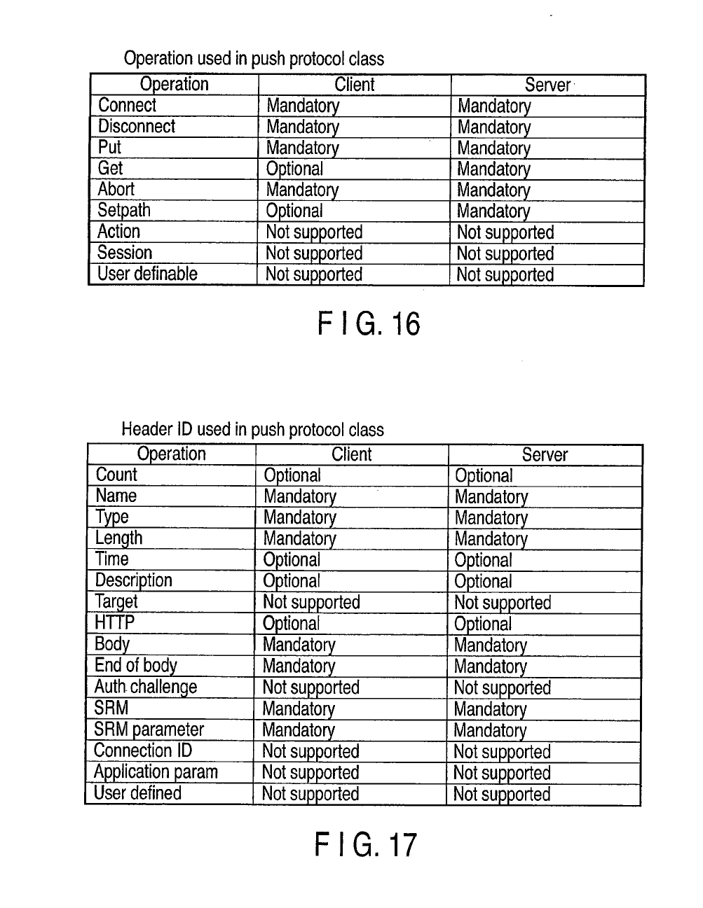

In the OBEX Application protocol class, communication is executed by using operations (a), (b), (c), (d), (e) and (f) in the range described below. As regards operations (commands) which are used in each of the file transfer protocol class 206 and push protocol class 212, a description will be given later (FIG. 16, FIG. 25).

(a) CONNECT Operation

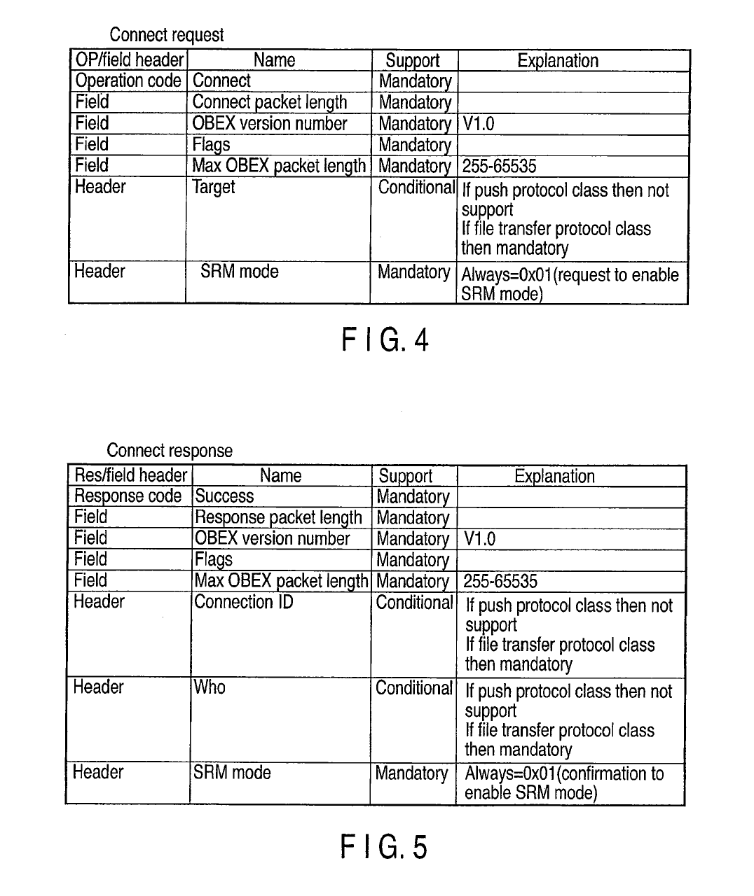

FIG. 4 shows “Field” and “Header” which are used in “CONNECT Request” of “CONNECT Operation”. FIG. 5 shows “Field” and “Header” which are used in “CONNECT Response” of “CONNECT Operation”. It is assumed that the “Header” in FIG. 4 and FIG. 5 conforms to the descriptions defined in the file transfer protocol class 206 and push protocol class 212, which will be described later.

(b) DISCONNECT Operation

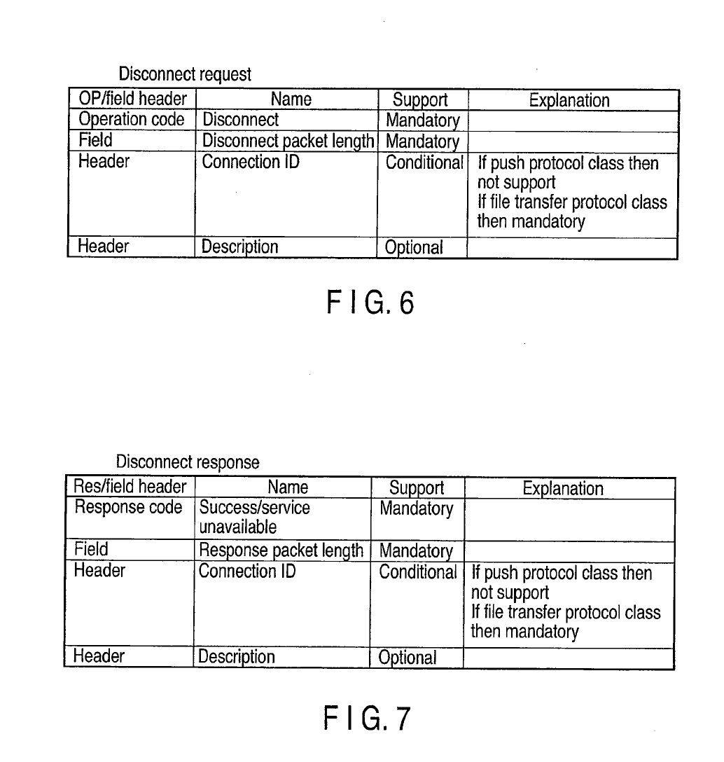

FIG. 6 shows “Field” and “Header” which are used in “DISCONNECT Request” of “DISCONNECT Operation”. FIG. 7 shows “Field” and “Header” which are used in “DISCONNECT Response” of “DISCONNECT Operation”. It is assumed that the “Header” in FIG. 6 and FIG. 7 conforms to the descriptions defined in the file transfer protocol class 206 and push protocol class 212, which will be described later.

(c) PUT Operation

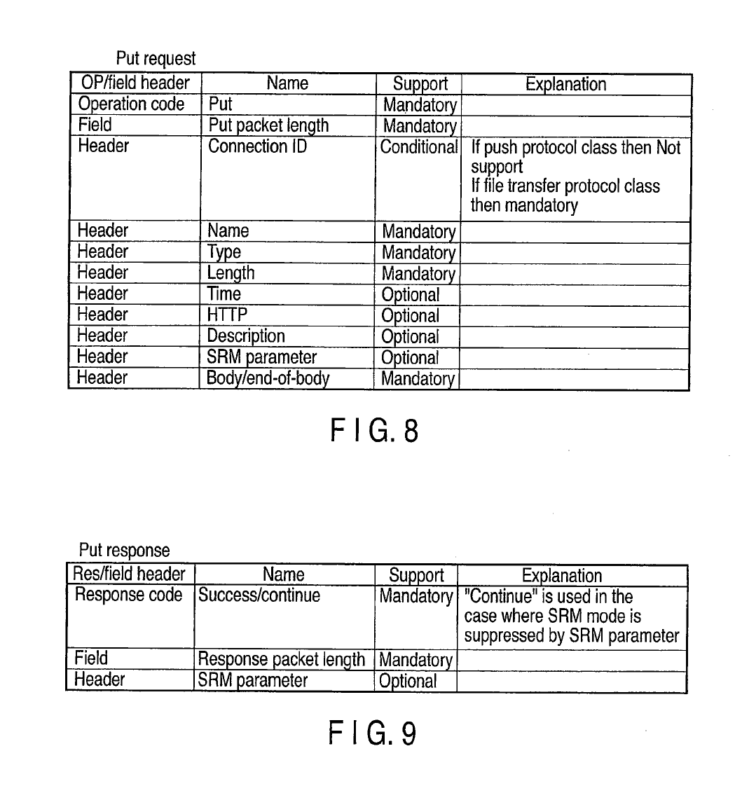

FIG. 8 shows “Field” and “Header” which are used in “PUT Request” of “PUT Operation”. FIG. 9 shows “Field” and “Header” which are used in “PUT Response” of “PUT Operation”. It is assumed that the “Header” in FIG. 8 and FIG. 9 conforms to the descriptions defined in the file transfer protocol class 206 and push protocol class 212, which will be described later.

(d) GET Operation

FIG. 10 shows “Field” and “Header” which are used in “GET Request” of “GET Operation”. FIG. 11 shows “Field” and “Header” which are used in “GET Response” of “GET Operation”. It is assumed that the “Header” in FIG. 10 and FIG. 11 conforms to the descriptions defined in the file transfer protocol class 206 and push protocol class 212, which will be described later.

(e) ABORT Operation

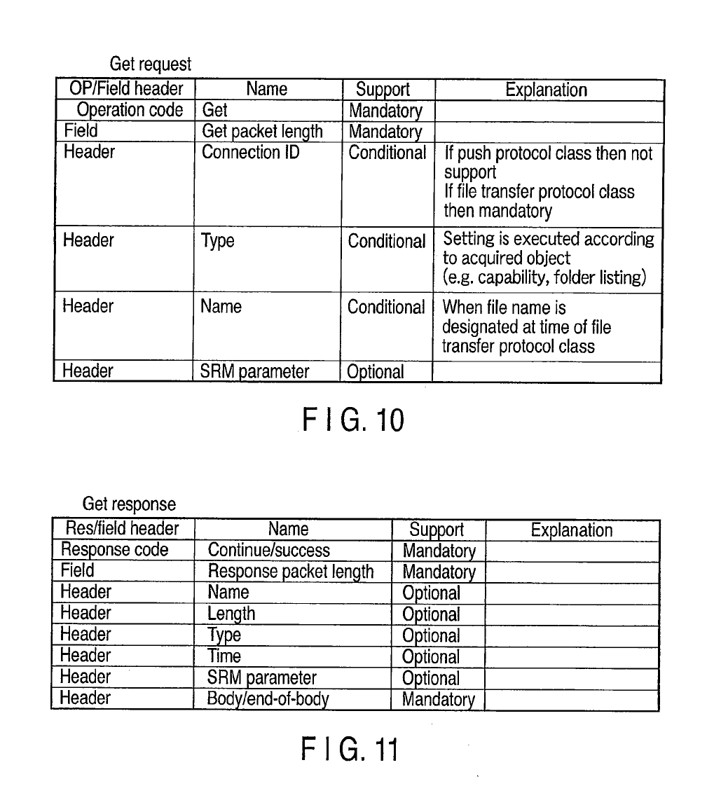

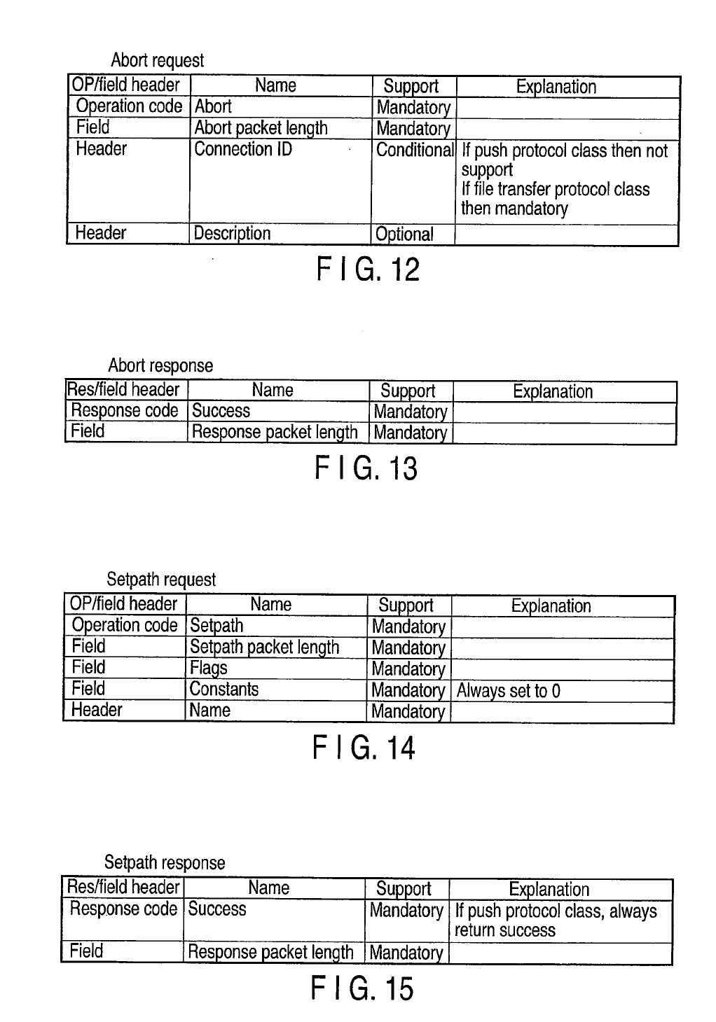

FIG. 12 shows “Field” and “Header” which are used in “ABORT Request” of “ABORT Operation”. FIG. 13 shows “Field” and “Header” which are used in “ABORT Response” of “ABORT Operation”. It is assumed that the “Header” in FIG. 12 and FIG. 13 conforms to the descriptions defined in the file transfer protocol class 206 and push protocol class 212, which will be described later.

(f) SETPATH Operation

FIG. 14 shows “Field” and “Header” which are used in “SETPATH Request” of “SETPATH Operation”. FIG. 15 shows “Field” and “Header” which are used in “SETPATH Response” of “SETPATH Operation”. It is assumed that the “Header” in FIG. 14 and FIG. 15 conforms to the descriptions defined in the file transfer protocol class 206 and push protocol class 212, which will be described later.

Next, the details of the push protocol class 212 are described.

The push protocol class 212 is used, for example, by the application 201, in order to transmit one or plural files from the client to the server. The format (Contents Format) of an object, which is transmitted by the push protocol class 212, is defined by “Generic File Object”.

FIG. 16 shows an operation which is used in the push protocol class 212 in each of the client and server, which execute data communication by close proximity wireless transfer. FIG. 17 shows “Header ID” which is used in the push protocol class 212.

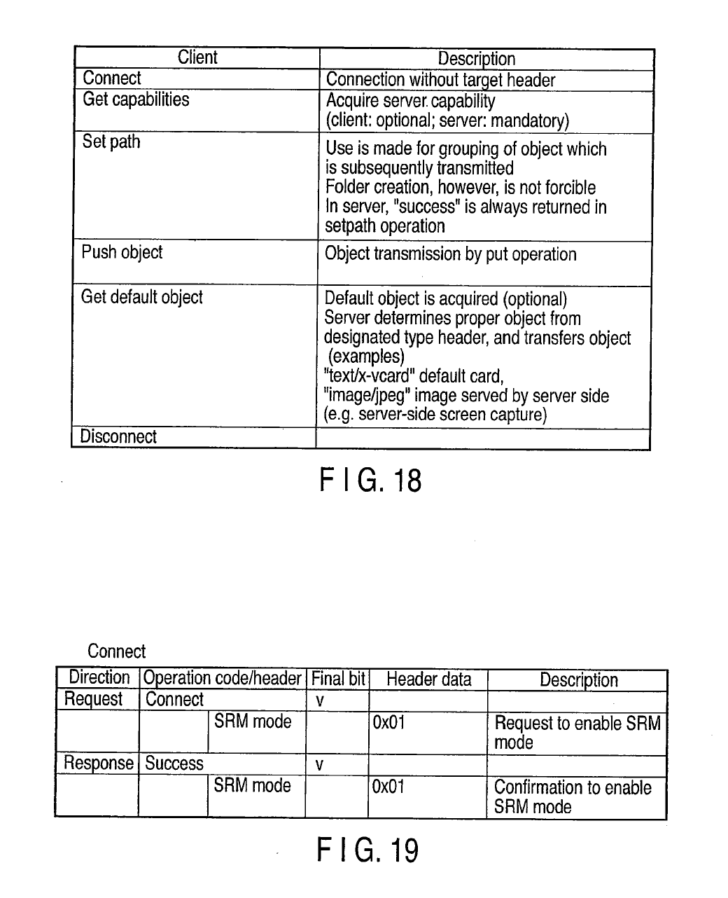

FIG. 18 illustrates procedures for providing services by the push protocol class 212. FIG. 19 to FIG. 24 illustrate sequence examples in the respective procedures shown in FIG. 18.

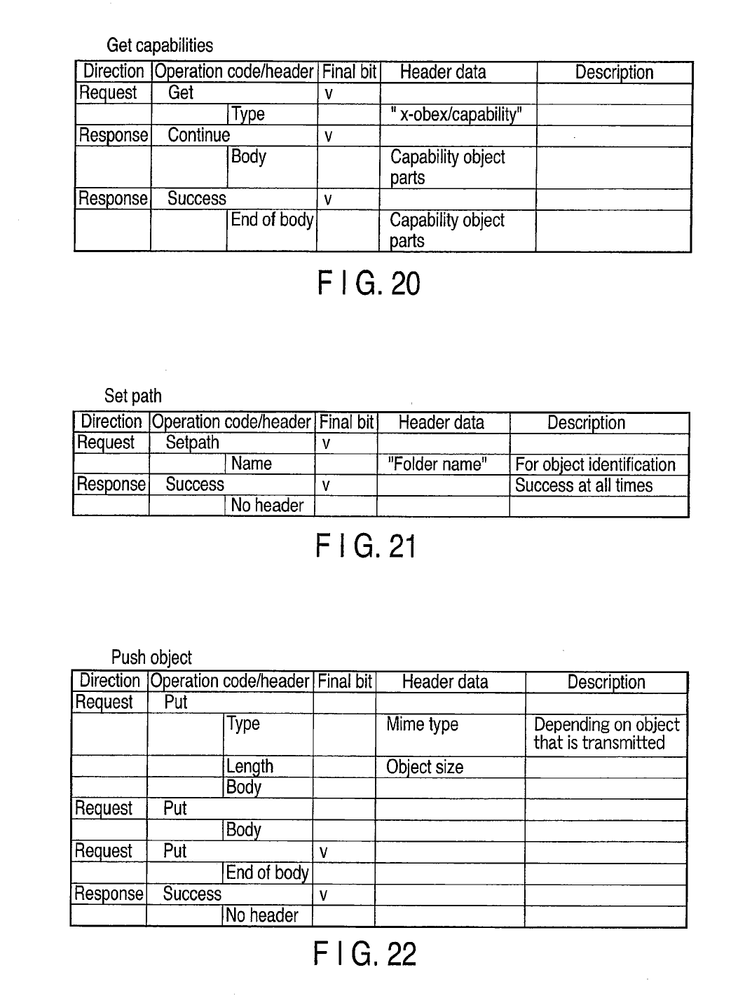

In the push protocol class 212, for example, in the case where a file transmission request is issued by the application 201 in the client, if close proximity wireless communication is enabled by the user's touch operation via the CNL 223 and PCL OBEX adapter 220, the connection to the application of the server is established by the “Connect” procedure by the CONNECT operation shown in FIG. 19. If the connection to the application of the server is established, the push protocol class 212 acquires, prior to the file transmission, the server capability by the “Get Capabilities” procedure by the GET operation shown in FIG. 20. It is assumed that the “Get Capabilities” procedure is arbitrarily executed.

Next, in order to transmit to the server the data for identifying the file (object) to be transmitted, the push protocol class 212 executes the “Set Path” procedure by the SETPATH operation shown in FIG. 21. In the SETPATH operation, as the data for identifying the file (object), for example, as shown in FIG. 21, “Folder Name” is reported to the server as the header data. In the present embodiment, it is assumed that the SETPATH operation does not force the server to create a folder.

After the SETPATH operation, the push protocol class 212 transmits the file of the common group (folder), which corresponds to the “Folder Name” that has been reported to the server, by the “Push Object” procedure by the PUT operation shown in FIG. 22. In the case where there is a plurality of files in the common group, the PUT operation (file transmission) for each file is repeatedly executed.

In addition, in the case where a plurality of groups (folders) are selected as objects of transmission, the “Set Path” procedure and “Push Object” procedure are repeatedly executed for each group.

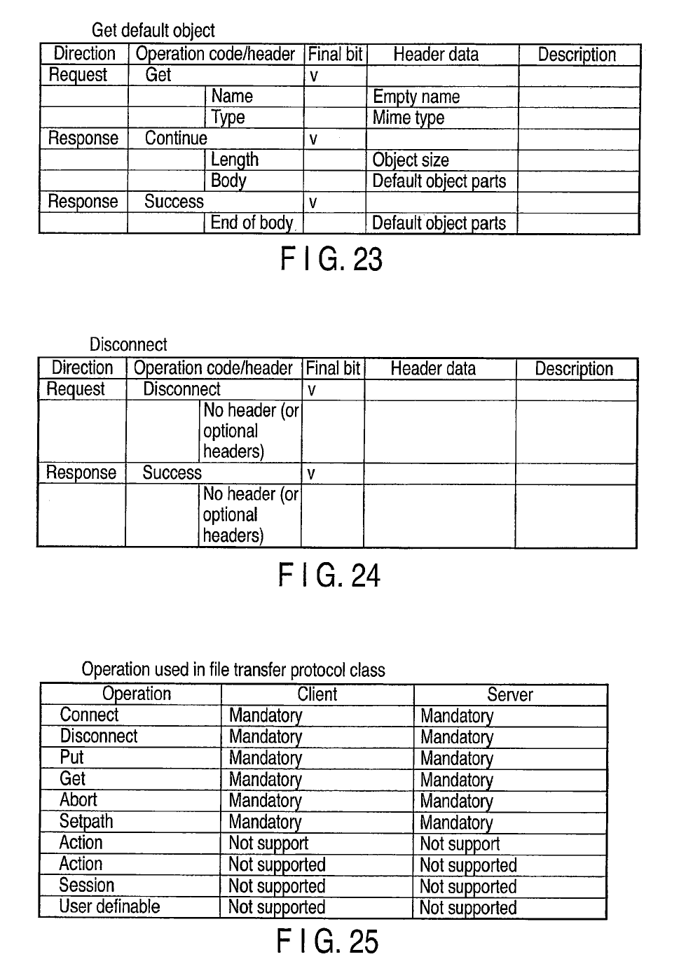

The push protocol class 212 executes, where necessary, the “Get Default Object” procedure by the GET operation shown in FIG. 23. The push protocol class 212 designates the data (object), which is the object of acquisition request, by the type header of the GET operation. Thereby, the server determines a proper object in accordance with the designated type header, and transmits the object to the client. For example, the client can receive the image data that is provided by the server (e.g. image data which is screen-captured in the server).

If the transmission of a file (object) is completed, the push protocol class 212 executes the “Disconnect” procedure by the DISCONNECT operation shown in FIG. 24.

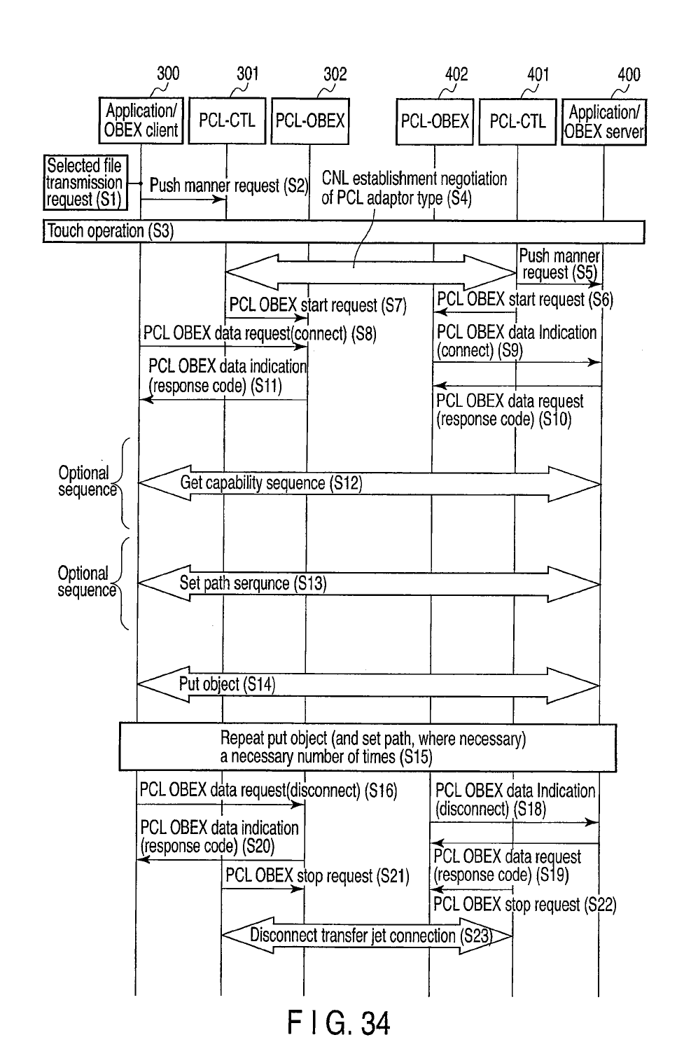

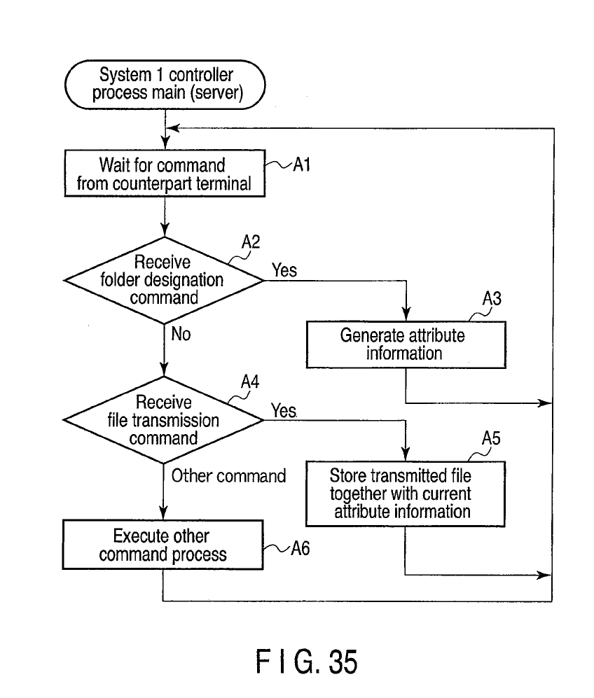

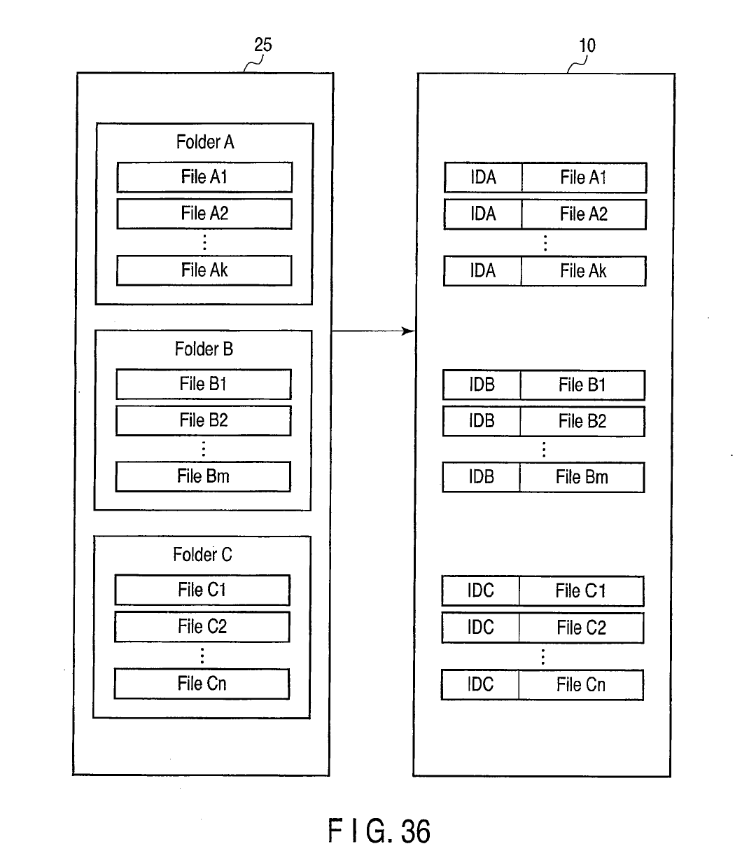

In the push protocol class 212 in the present invention, in the case where plural files are to be transmitted from the client to the server, the plural files can be transmitted to the server by the procedures of “Set Path” and “Push Object”, without the user performing time-consuming operations, and the plural files can be grouped in the server. A concrete operation of transmitting plural files from the client to the server will be described later (FIG. 34, FIG. 35, FIG. 36).

Next, the details of the file transfer protocol class 206 are described.

The file transfer protocol class 206 is used, for example, by the application 202, in order to execute transmission/reception of one or plural files between the client and the server. The format (Contents Format) of an object, which is transmitted by the file transfer protocol class 206, is defined by “Generic File Object”.

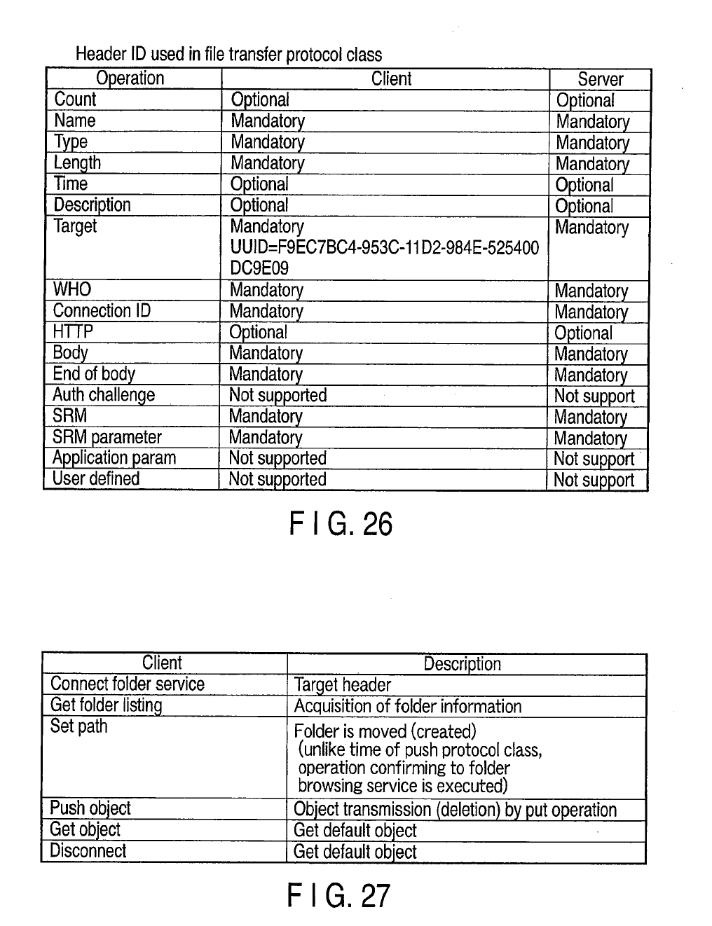

FIG. 25 shows an operation which is used in the file transfer protocol class 206 in each of the client and server, which execute data communication by close proximity wireless transfer. FIG. 26 shows “Header ID” which is used in the file transfer protocol class 206.

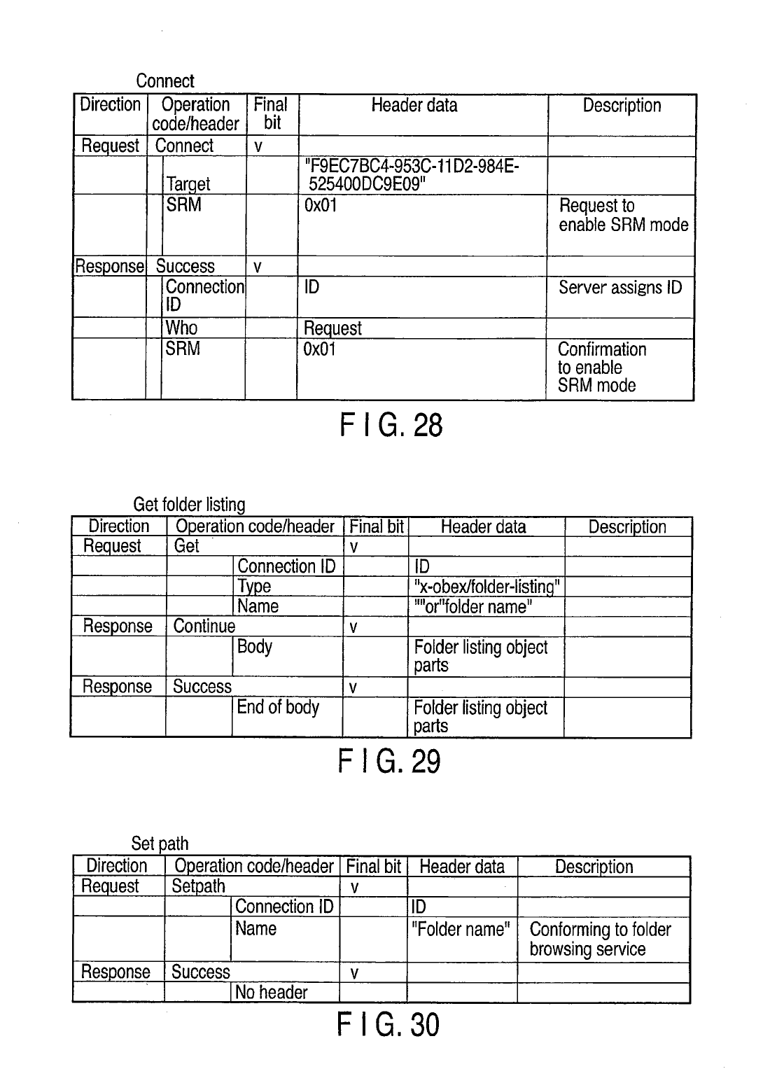

FIG. 27 illustrates procedures for providing services by the file transfer protocol class 206. FIG. 28 to FIG. 33 illustrate sequence examples in the respective procedures shown in FIG. 27.

In the file transfer protocol class 206, for example, in the case where a file transmission request is issued by the application 202 in the client, if close proximity wireless communication is enabled by the user's touch operation via the CNL 223 and PCL OBEX adapter 220, the connection to the application of the server is established by the “Connect” procedure by the CONNECT operation shown in FIG. 28. If the connection to the server is established, the file transfer protocol class 206 acquires, prior to the file transmission, the data (folder information), which is indicative of the folder and file at the transmission destination of the file in the server, by the “Get Folder Listing” procedure by the GET operation shown in FIG. 29.

Next, in order to move (create) a folder, the file transfer protocol class 206 executes the “Set Path” procedure by the SETPATH operation shown in FIG. 30. In the SETPATH operation, for example, as shown in FIG. 30, “Folder Name” is reported to the server as the header data. In the SETPATH operation by the file transfer protocol class 206, unlike the push protocol class 212, the operation conforming to the folder browsing service 210 is performed.

Specifically, in the push protocol class 212, a transmission process is executed in one direction from the client. On the other hand, in the file transfer protocol 206, a file can be transmitted to an arbitrary folder, but the file transmission is performed while information is being acquired from the server. Thus, the process becomes complex, and the file transfer protocol 206 is not suited to high-speed file transfer.

After the SETPATH operation, the file transfer protocol class 206 executes transmission (or deletion) by the “Push Object” procedure by the PUT operation shown in FIG. 31. In the case where there is a plurality of files which are to be transmitted, the PUT operation (file transmission) for each file is repeatedly executed.

In addition, the file transfer protocol class 206 executes, where necessary, the “Get Object” procedure by the GET operation shown in FIG. 32. The file transfer push protocol class 206 designates the file name of the data (object), which is the object of acquisition request, by the type header of the GET operation.

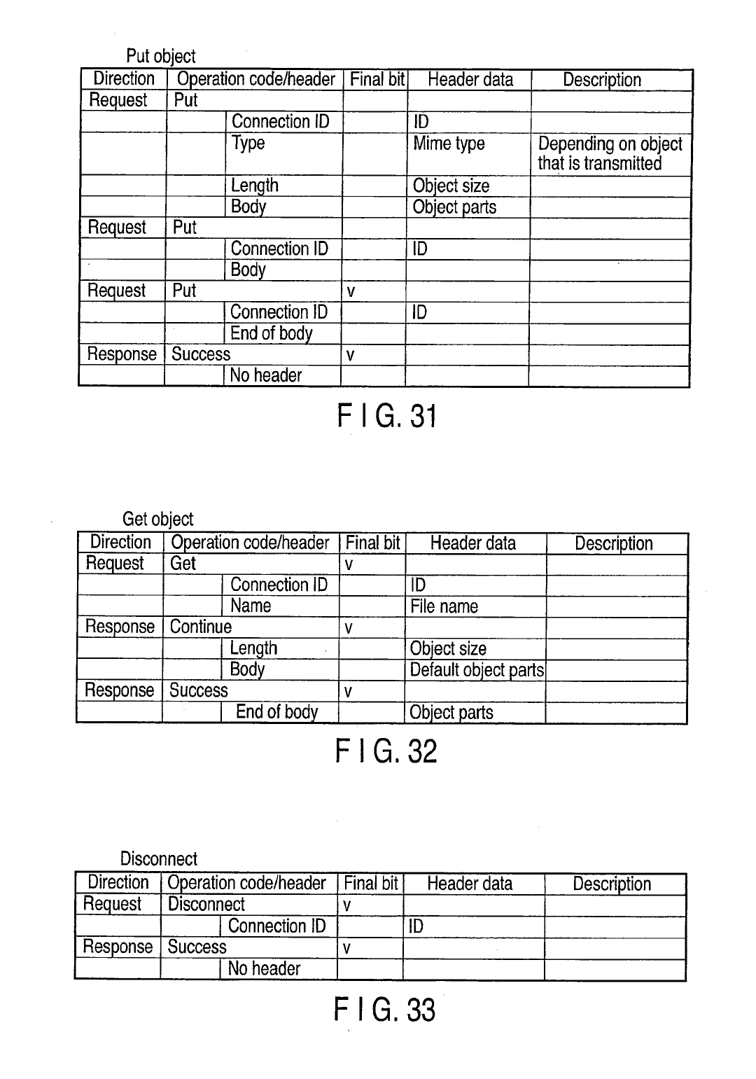

If the transmission of a file (object) is completed, the file transfer protocol class 206 executes the “Disconnect” procedure by the DISCONNECT operation shown in FIG. 33.

Next, the operation of the file transmission of the electronic apparatus in the present embodiment is described. In particular, a description is given of a concrete operation in which the application 201 transmits plural files to the server by using the push protocol class 212.

FIG. 34 shows a sequence which is executed between the client and the server, which execute file transmission/reception. In the description below, for example, it is assumed that the client, which transmits a file, is the digital camera 25, and the server, which receives the file, is the personal computer 10. It is also assumed that a moving picture is photographed and a moving picture title is recorded in the digital camera 25. The moving picture title is composed of, e.g. a plurality of files. Thus, when the moving picture title is to be transmitted to the personal computer 10, it is necessary to mutually associate the plural files included in the moving picture title.

The push protocol class 212 of the OBEX protocol 203 in the embodiment executes, without performing a special procedure in advance, grouping of a plurality of files which are to be transmitted from the digital camera 25 to the personal computer 10.

In FIG. 34, an application/OBEX client 300 corresponds to the application 201 and OBEX protocol 203 in the digital camera 25, a PCL-CTL 301 corresponds to the PCL controller 221, and a PCL-OBEX 302 corresponds to the PCL OBEX adapter 220. Similarly, an application/OBEX server 400 corresponds to the application 201 and OBEX protocol 203 in the personal computer 10, a PCL-CTL 401 corresponds to the PCL controller 221, and a PCL-OBEX 402 corresponds to the PCL OBEX adapter 220.

To start with, in the digital camera 25, by the process by the application, the selection of a file that is the object of transmission to the personal computer 10 and the transmission request are executed according to the user operation (S1). For example, assume that a file that is the object of transmission to the personal computer 10 has been selected by the user operation from among a plurality of moving picture titles recorded in the digital camera 25. In this case, it is assumed that a folder in which the moving picture file is recorded has been selected or a moving picture title comprising a plurality of files has been designated, and thus a plurality of files have been selected as the object of transmission. Although the moving picture files are taken as an example, other files (objects) may be selected as the object of transmission.

The application/OBEX client 300 issues a request for transmission of the files by the push protocol class 212 to the PCL-CTL 301 (PCL controller 221) (S2).

The digital camera 25 transitions to the connection standby state until close proximity wireless transfer with the electronic apparatus (personal computer 10) that is the transmission destination of files is enabled. In addition, it is assumed that the personal computer 10 is in the connection standby state for the close proximity wireless transfer.

It is assumed that the user has executed the touch operation for bringing the digital camera 25 close to the personal computer 10 (S3). Specifically, it is assumed that the distance between the antenna 26 for close proximity wireless transfer of the digital camera 25 and the antenna 21 for close proximity wireless transfer of the personal computer 10 has decreased so that the close proximity wireless transfer is enabled (e.g. about 3 cm).

If transition is made to the state in which the close proximity wireless transfer is enabled, physical connection is established between the PCL-CTL 301 of the digital camera 25 and the PCL-CTL 401 of the personal computer 10, and the type of PCL adapter (communication adapter) corresponding to the protocol of the application is adjusted (S4).

Specifically, the PCL-CTL 301 (PCL controller 221) of the digital camera 25 executes a process of establishing (physical) connection to the personal computer 10 (close proximity wireless transfer device 104) in the close proximity state by using the CNL 223. Similarly, the PCL-CTL 401 of the personal computer 10 executes a process of establishing (physical connection) to the digital cameral 25.

In addition, the PCL-CTL 301 (PCL controller 221) executes a negotiation process, thereby transmitting to the PCL-CTL 401 session information relating to a session to be established, for example, session information including information indicative of the communication adapter that is to be used, information indicative of the type of data that is to be transmitted by the application, and information identifying the application. On the basis of the session information from the PCL-CTL 301, the PCL-CTL 401 (PCL controller 221) activates the communication adapter corresponding to the protocol of the application 201 that has sent the new session start request, for example, the PCL OBEX adapter 220 in this embodiment, thereby establishing the session that is used for the application 201 to communicate with the application of the external device via the close proximity wireless transfer device 104. Further, in accordance with the information identifying the application, the PCL-CTL 401 activates the application corresponding to the same OBEX protocol 203 as the application 201 of the digital camera 25.

If the session is established, the PCL-CTL 401 of the personal computer 10 issues to the application/OBEX server 400 a request for file transmission by the push protocol class 212 (S5). In addition, the PCL-CTL 401 issues to the PCL-OBEX 402 (PCL OBEX adapter 220) a request for the start of transmission by the OBEX protocol 203 (S6). Similarly, also in the digital camera 25, the PCL-CTL 301 issues to the PCL-OBEX 302 (PCL OBEX adapter 220) a request for the start of transmission by the OBEX protocol 203 (S7).

The application/OBEX client 300 and application/OBEX server 400 (push protocol class 212) executes the “Connect” procedure by the CONNECT operation shown in FIG. 19 via the PCL-OBEX 302,402 (S8 to S11).

In the subsequent process, the application/OBEX client 300 and application/OBEX server 400 operate according to the procedure of providing the service by the push protocol class 212 shown in FIG. 18.

Specifically, the application/OBEX client 300 acquires the server capability from the application/OBEX server 400 by the “Get Capabilities” procedure by the GET operation shown in FIG. 20 (S12).

Then, the application/OBEX client 300 (push protocol class 212) executes the “Set Path” procedure by the SETPATH operation shown in FIG. 21, thereby to transmit to the server the data for identifying the file that is to be transmitted (S13). In the SETPATH operation, for example, as shown in FIG. 21, the “Folder Name” that is the header data is reported to the server as the data for identifying the file (object). The application/OBEX server 400 (push protocol class 212) always responds to the SETPATH operation by the SUCCESS operation.

After the SETPATH operation, the application/OBEX client 300 transmits the files of the common group (folder), which corresponds to the “Folder Name” reported to the application/OBEX server 400, by the “Push Object” procedure by the PUT operation, which is shown in FIG. 22 (S14). In the case where a plurality of files are present in the common group, the PUT operation (file transmission) for each file is repeatedly executed (S15). Besides, the SETPATH operation and the PUT operation (file transmission) are repeatedly executed, where necessary, for example, in the case of transmitting files in connection with plural groups.

The application/OBEX server 400 on the server side stores a plurality of files, which are transmitted from the application/OBEX client 300, by grouping these files. Next, a description is given of the procedure on the server side for storing a plurality of files, which are received from the client, by grouping these files.

FIG. 35 is a flow chart illustrating the operation of the application/OBEX server 400.

If the application/OBEX server 400 receives from the client (application/OBEX client 300) the folder name corresponding to the file, which is the object of transmission, by the SETPATH operation (folder designation command) (block A1, A2), the application/OBEX server 400 creates the attribute information for identifying the file that is transmitted by the PUT operation (file transmission command) after the SETPATH operation, on the basis of the folder name that has been received by the SETPATH operation (block A3).

If the application/OBEX server 400 receives the file by the PUT operation (file transmission command) (Yes in block A4), the application/OBEX server 400 stores the transmitted file together with the current attribute information generated in block A3 (block A5). Thereafter, in the case where a plurality of files are present in'the common group, the application/OBEX server 400 receives the plural files, which are transmitted from the client by the PUT operation (file transmission command), and stores the files together with the common attribute information (block A4, A5).

Further, in the case where a plurality of files included in a different group are transmitted from the client, the application/OBEX server 400 newly receives the “Folder Name” for identifying the files of the different group by the SETPATH operation (folder designation command), and generates the attribute information in the same manner as described above (block A2, A3). Then, the application/OBEX server 400 stores, together with the attribute information, the files which are subsequently transmitted by the PUT operation (file transmission command).

In the case where the application/OBEX server 400 has received some other command (e.g. the “Get Default Object” procedure by the GET operation shown in FIG. 18, FIG. 23), the application/OBEX server 400 executes the process corresponding to the command (block A6).

FIG. 36 illustrates grouping of files in the case where a plurality of files are transmitted from the digital camera 25 to the personal computer 10.

For example, assume that in the digital camera 25, folders A, B and C (or moving picture titles) have been selected by the user as objects of transmission. As shown in FIG. 36, the folder A includes a plurality of files A1, A2, . . . , Ak. Similarly, the folder B includes a plurality of files B1, B2, . . . , Bm, and the folder C includes a plurality of files C1, C2, . . . Cn.

In the case where files are transmitted from the digital camera 25 by the procedure by the push protocol class 212, the folder name corresponding to the folder A is reported to the server by the SETPATH operation (folder designation command).

In the personal computer 10, the application/OBEX server 400 generates, e.g. attribute information “IDA”, on the basis of the folder name corresponding to the folder A, and stores, together with the attribute information “IDA”, the files A1, A2, . . . , Ak, which have been transmitted by the PUT operation (file transmission command). Thereby, in the personal computer 10, the plural files A1, A2, . . . , Ak can be grouped by the attribute information “IDA”, and can be managed as mutually associated files, to which a meaning is attached.

Similarly, in the personal computer 10, the plural files B1, B2, . . . , Bm can be grouped by the attribute information “IDB” and stored, and the plural files C1, C2, . . . , Cn can be grouped by the attribute information “IDC” and stored.

If the transmission of the files from the digital camera 25 to the personal computer 10 is completed, the application/OBEX client 300 and application/OBEX server 400 (push protocol class 212) execute the “Disconnect” procedure by the DISCONNECT operation shown in FIG. 24 via the PCL-OBEX 302, 402 (S16 to S20).

In addition, the PCL-CTL 301 issues a request for finishing the communication by the OBEX protocol 203 to the PCL-OBEX 302 (PCL OBEX adapter 220) (S21). Similarly, in the personal computer 10, the PCL-CTL 401 issues a request for finishing the communication by the OBEX protocol 203 to the PCL-OBEX 402 (PCL OBEX adapter 220) (S22).

Then, the PCL adapter (communication adapter) corresponding to the protocol of the application is stopped between the PCL-CTL 301 of the digital camera 25 and the PCL-CTL 401 of the personal computer 10, and the close proximity wireless transfer is disconnected (S23).

As has been described above, in the case where the plural files are transmitted from the client (digital camera 25) to the server (personal computer 10), the procedure by the push protocol class 212 of the OBEX protocol 203 is executed. Thereby, the plural files can be grouped and stored in the server, without performing a user operation of mutually associating the plural files, designating the storage destination of the files to the transmission destination (server) of the files, or creating in advance a list in which the structures of files are recorded. In other words, the transfer of plural files by high-speed, close proximity wireless transfer can be realized simply by a touch operation of bringing devices close to each other, without a time-consuming user operation for mutually associating plural files. Moreover, in the server (personal computer 10), plural files belonging to a common group can be identified by referring to the attribute information which is recorded together with the files, and the plural files can be processed as data (e.g. moving picture data) having a single meaning.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a coupler;
a communication module configured to execute, with use of the coupler, wireless communication with an external device; and
a file transmission module configured to execute file transmission with the external device by controlling the communication module, the file transmission module comprising:
a module configured to receive from the external device a first path designation command, which includes a header designating a first folder name, in a push protocol;
a module configured to receive from the external device a first file by a push command for pushing data in the push protocol; and
a module configured to store the first folder name designated by the first path designation command and the first file that is received by the push command after the first path designation command.

2. The electronic apparatus of claim 1, wherein the file transmission module further comprises a module configured to associate the first file received by the push command and the first folder name designated by the header of the first path designation command.

3. The electronic apparatus of claim 1, wherein the file transmission module comprises:
a module configured to receive from the external device a second path designation command, which includes a header designating a second folder name, in a file transfer protocol;
a module configured to receive from the external device a command for transmitting a second file in the file transfer protocol; and
a module configured to determine a folder for use in file transmission after the second path designation command, in accordance with the second folder name in the second path designation command in the file transfer protocol.

4. An electronic apparatus comprising:
a coupler;
a communication module configured to execute, with use of the coupler, wireless communication with an external device; and
a file transmission module configured to execute file transmission with the external device by controlling the communication module, the file transmission module comprising:
a module configured to transmit to the external device a first path designation command, which includes a header designating a first folder name, in a push protocol; and
a module configured to transmit to the external device a first file by a push command for pushing data in the push protocol.

5. The electronic apparatus of claim 4, wherein the file transmission module comprises:
a module configured to transmit to the external device a second path designation command, which includes a header designating a second folder name, in a file transfer protocol; and
a module configured to transmit to the external device a command for transmitting a second file in the file transfer protocol.

6. A communication control method for wireless communication with use of a coupler, comprising:
receiving a path designation command, which includes a header designating a folder name, in a push protocol;
receiving a file by a push command for pushing data in the push protocol; and
storing the folder name designated by the path designation command and the file that is received by the push command after the path designation command.
